(19) United States
(12) Patent Application Publication
(10) Pub. No.: US 2014/0007374 A1
(43) Pub. Date: Jan. 9, 2014

(54) DOOR BLOCK

(71) Applicant: Dean S.L. BAKER, Hawk Springs, WY (US)

(72) Inventor: Dean S.L. BAKER, Hawk Springs, WY (US)

(21) Appl. No.: 13/543,456

(22) Filed: Jul. 6, 2012

(51) Int. Cl. E05F 5/00

(52) U.S. Cl. 16/82

(57) ABSTRACT

A door stop or door block is provided which prohibits opening of a door from only one when weighted. The door stop may comprise a base portion with an extension that extends upward from a portion of one edge of the base portion.

### BACKGROUND OF THE INVENTION

A doorstop (also door stopper or door stop) is an object or device used to hold a door open or closed, or to prevent a door from opening too widely. Alternatively, a doorstop can be a thin slat built inside a door frame to prevent a door from swinging through when closed. A door may be held open by a door stop which is simply a heavy solid object, such as a rubber, placed in the path of the door. Historically, lead bricks have been popular choices when available. Another method is to use a door stop which is a small wedge of wood, rubber, plastic, cotton or another material. Manufactured wedges of these materials are commonly available. The wedge is kicked into position and the downward force of the door, now jammed upwards onto the doorstop, provides enough static friction to keep it motionless. A third strategy is to equip the door itself with a stopping mechanism. In this case, a short metal bar capped with rubber, or another high friction material, is attached to a hinge near the bottom of the door opposite the door hinge and on the side of the door which is in the direction that it closes. When the door is to be kept open, the bar is swung down so that the rubber end touches the floor. In this configuration, further movement of the door towards being closed increases the force on the rubber end, thereby increasing the frictional force which opposes the movement When the door is to be closed, the stop is released by pushing the door slightly more open which releases the stop and allows it to be flipped upwards. A newer version of equipping the door with the stopping mechanism is to attach a magnet to the bottom of the door on the side which opens outward which then latches onto another magnet or magnetic material on the wall or a small hub on the floor. The magnet must be strong enough to hold the weight of the door, but weak enough to be easily detached from the wall or hub. Another strategy may be to equip a pole from below a door handle at an angle to the floor. Much as other door stops operate, the more force that is applied to the door, the more friction will be created. The bottom of the pole may even be affixed to the floor in a removable fashion.

### SUMMARY OF THE INVENTION

An embodiment of the invention may therefore comprise an apparatus for stopping a door from opening, comprising a base comprising an upper face and a lower face, and a perpendicular extension extending upward from at least a portion of the base, wherein said apparatus is enabled to block a door from opening in one direction when weighted by a person such that the apparatus is immovable.

An embodiment of the invention may therefore comprise a method of preventing a door from opening in only one direction, comprising placing a door block apparatus adjacent to the door, and standing on the door block apparatus, wherein said door block apparatus comprises a base portion and a perpendicular extension situated so that the extension nearly abuts the door and enabled to contact the floor in a frictional manner when stood upon.

### BRIEF DESCRIPTION OF THE DRAWINGS

FIG. 1 is a top view of an embodiment of a door block.

FIG. 2 is a top view of an embodiment of a door block and door.

FIG. 3 is a perspective view of an embodiment of a door block.

FIG. 4 is a front view of an embodiment of a door block.

FIG. 5 is a bottom view of an embodiment of a door block.

FIG. 6 is a side view of an embodiment of a door block.

FIG. 7 is a perspective view of an embodiment of a door block.

FIG. 8 is a perspective view of an embodiment of a door block with a curved edge.

### DETAILED DESCRIPTION OF THE EMBODIMENTS

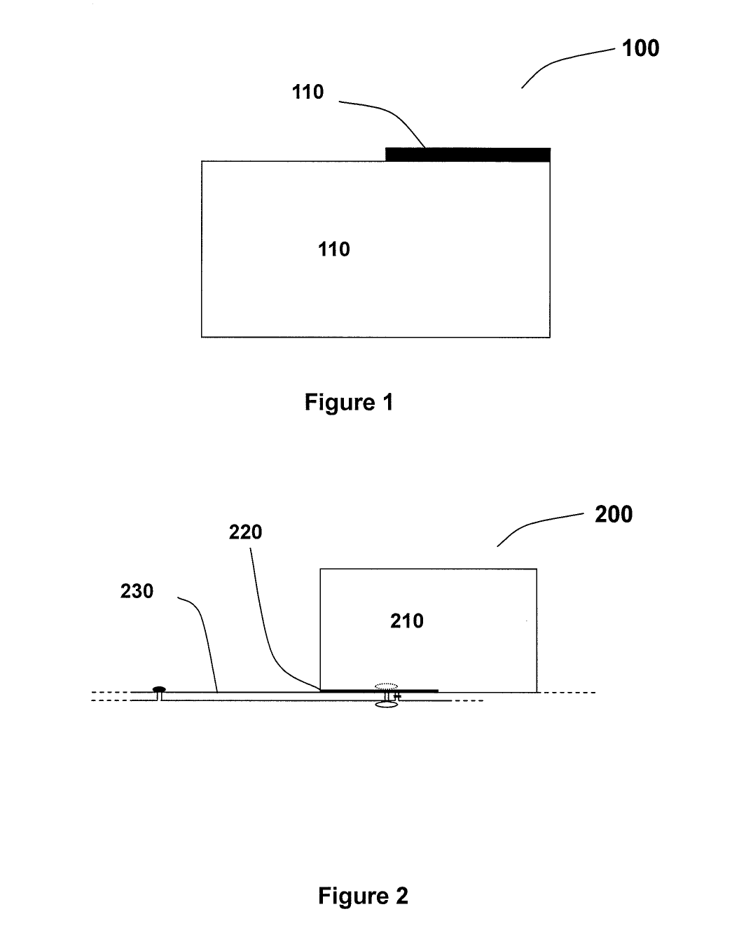

FIG. 1 is a top view of an embodiment of a door block. The door block apparatus 100 comprises a base portion 110 and an extension 120. The extension 120 extends upward from the base portion 110 in a perpendicular manner. The top edge of the extension 120 can be seen. It is understood that the extension 120 can extend upward from the base 110 over a range of the edge. In operation, the apparatus 100 is placed in from of a door (not shown). At a minimum, the extension 120 will about the bottom of the door. To open the door, a person will step on the base 110 and attempt to pull the door open. The weight of the person on the apparatus 100 will cause the base 110 to firmly contact the floor. It is understood that it is not possible for a person to lift themselves unaided by some sort of mechanical apparatus. Accordingly, the door will not open due to weight of the person and the impact between the door and the extension 120.

Only a person standing on the side of the door to which the door swings will be prevented from opening the door. As noted, the weight of the person opening the door from the side of the apparatus 100 will prevent the apparatus 100 from moving. Contrarily, a person standing on the side of the door opposite the apparatus 100 will not be prevented from opening the door. This provides an important access point in the event of emergencies. Predominantly, the apparatus will be utilized in situations where individuals will be prevented from exiting a room or building, but fire, police and other emergency personnel will be able to easily push a door open and the apparatus 100 will easily slide with the door since no weight will be on the apparatus 100. Individuals that may be very young, have varying degrees of autism, or perhaps suffer from Alzheimer's, will be prevented from exiting, or entering, through the door.

FIG. 2 is a top view of an embodiment of a door block with a door. The apparatus 200 is placed next to a door 230 which swings in the direction of the apparatus 200. The extension 220 is seen abutting the door 230. The base 210 of the apparatus 200 projects outward away from the door 230. The base 210 may be predominantly under and protect outward from the handle of the door 230. It is understood that the size of the base 210 may vary depending on circumstances. A smaller base 210 may be utilized in situations where a child is to be prevented from using a door. A larger base 210 may be utilized in situations where teens or adults are to be prevented from using a door. Also, it is understood that the shape of the base 210 is variable. The base 210 may be a semi-circle. The base 210 may be customized in size and shape to accommodate furniture.

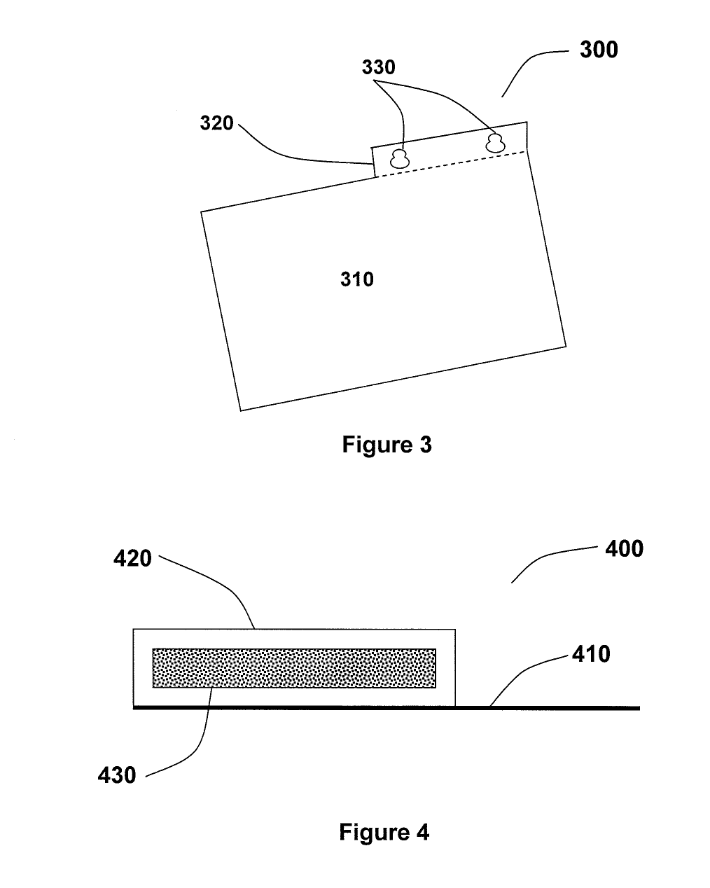

FIG. 3 is a perspective view of an embodiment of a door stop. The apparatus 300 has a base 100. An extension 320 is at one edge of the base 310 and extends upward from the base 310. The extension 320 is shown to extend from a portion of the base 310. It is understood that the portion of the edge of the base 310 that the extension 320 extends from is variable. The extension 320 may run along an entire edge of the base 310. Or, as shown, the extension 320 may only cover a portion of the base 310 edge. This allows for customization to accommodate furniture and molding patterns in a room. Molding on a wall may interfere with an extension 320 that extends along an entire edge. Although an apparatus 300 with a full length extension 320 will still perform functionally to inhibit opening of a door, it may not be flush with the door. Also show are two screw holes 330 in the extension. The apparatus may be secured to the wall with screws. The heads of the screws (not shown) will fit entirely through a larger part of the screw holes 330 and then the narrow part of a screw will fit in the smaller part of the screw holes 330. This allows the apparatus 300 to be firmly attached to a door to prevent removal by a child or impaired adult. The apparatus 300 is easily removable when not needed by simply lifting. It is understood that when the apparatus is secured to the door, it will rest, unweighted, just above the floor or in contact with the floor so that weight supplied by a person will securely push the apparatus 300 to the floor.

FIG. 4 is a front view of an embodiment of a door block. The extension 420 extends upward from the base 410. A tacky surface 430 is attached to the extension 420. The tacky surface 430 is such that it will match up with a compatible surface that may be affixed to the door. Contact between the tacky surface 430 and the compatible surface will allow the apparatus 400 to be held in place. The tacky surface 430 may be a Velcro type product. The tacky surface 430 may also be such that it sticks to the compatible surface, or directly to the door (with a compatible surface) and allows for easy removal. Such sticky type products are known in the art and may easily be applied to the extension 420.

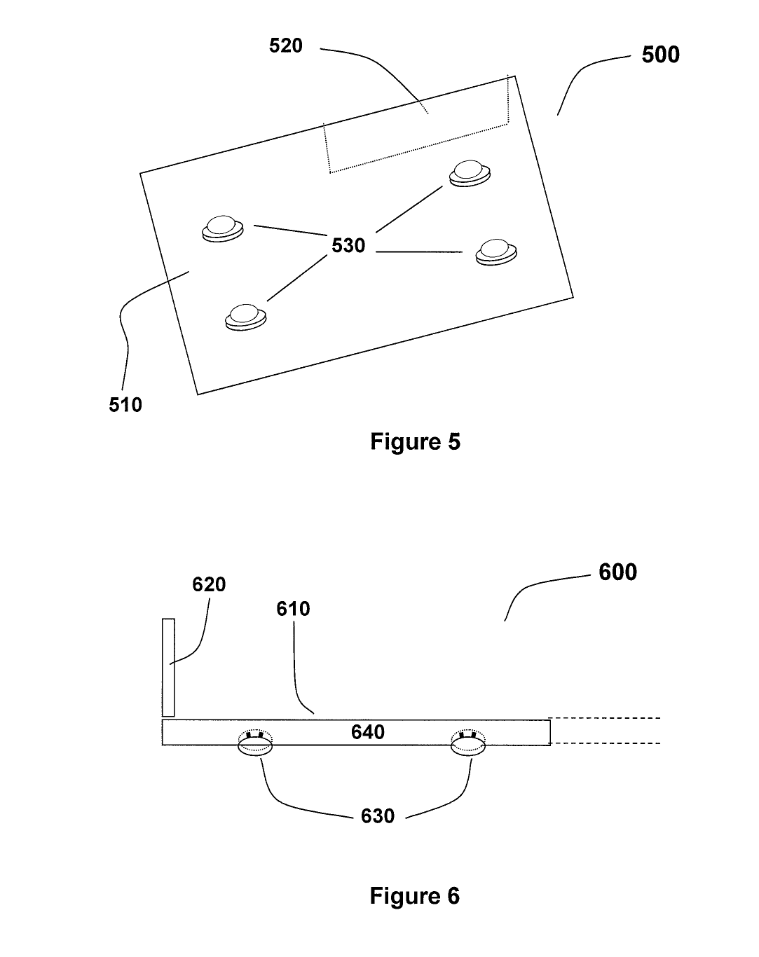

FIG. 5 is a bottom view of an embodiment of a door stop. The bottom of the base 510 is shown with the extension 520 projecting downward. On the underside of the base 510 are movement devices 530 which allow the apparatus to easily slide when not weighted. The devices 530 may be skids which slightly protrude from the bottom face of the base 510, for example. The devices 530 may be retractable wheels which also slightly protrude from the bottom face of the base 510, for example.

FIG. 6 is a side view of an embodiment of a door block with bottom devices. The base 610 of the apparatus 600 is shown having sufficient thickness to allow a plurality of movement devices 630 to be placed on the bottom of the base 610. It is understood that the thickness of the apparatus may be minimized by placing simple skids on the bottom as movement devices 630. The skids may be made of any material that allows movement of the apparatus 600. This may include plastics or silicones. Also, retractable wheels may be the movement devices 630. Weight placed on the top of the apparatus 600 will cause retraction of the wheels so that the bottom of the base 610 will contact the floor.

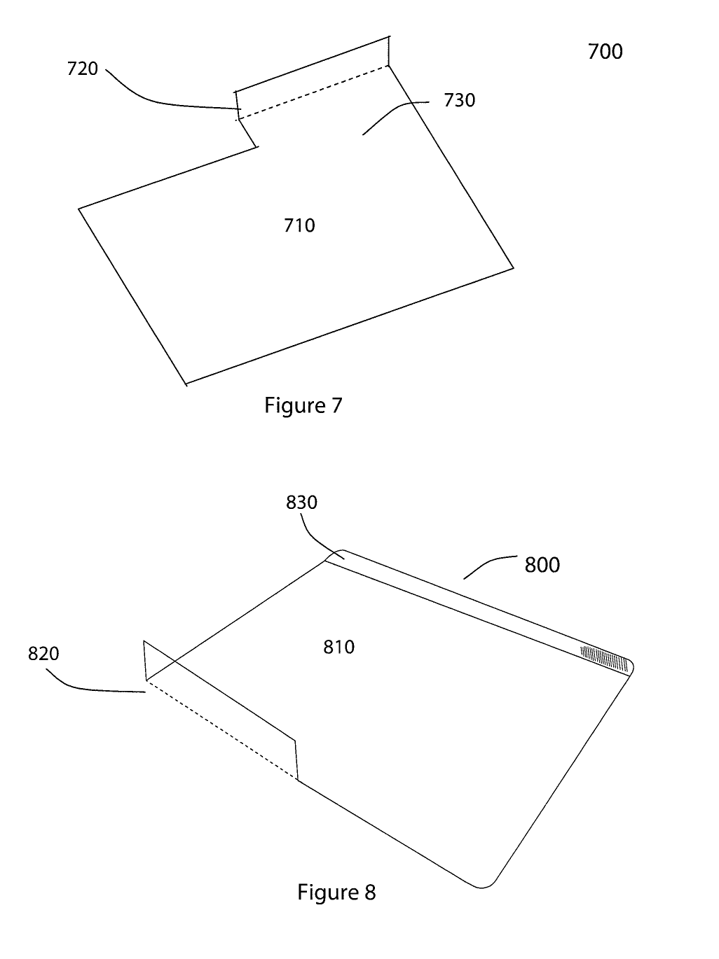

FIG. 7 is a perspective view of an embodiment of a door block. The apparatus 700 has a base 710 and extension 720 which extends upward from the base 710. The base also comprises an under door portion 730. The under door portion 730 may also be connected to the base 710 but be a separate element. As such, the under door portion 730 may be of separate construction firmly attached to the base 710, but it may also be of a single piece of construction with the base 710. The under door portion 730 may not extend the entire width of the base 710. This is to allow the under door portion 730 to be put under a door (not shown) and the cut out portion 740 would remain on the other side of the door and be allowed to engage with a wall or other structure in the house. The under door portion 730 allows the apparatus 700 to be utilized with doors that may open to the outside of where the base 700 will engage the floor. From the outside, in emergency situations or otherwise, the door may be opened with ease. It is understood that any and all securement devices and movement devices are usable with this embodiment. It is also understood that the under door portion is a portion of the apparatus 700 which allows the apparatus to fit under a door. The base 710 will remain in the room from which the door is intended not to be opened.

FIG. 8 is a perspective view of an embodiment of a door block with a curved edge. The apparatus 800 comprises a base 810 with an extension 820 which extends upward from the base 800 from a portion of the back edge of the base 800. On the edge of the base opposite the extension 820 is a curved portion 830. The curved portion 830 runs along the entirety of the front edge of the base 800. The curved portion 830 minimizes the risk of having the back edge snag on some impediment or unevenness of the floor (or rug) when the door is opened from the opposite side of the door.

It is understood that friction alone does not affect the inability of a person to open a door using an apparatus of an embodiment of the invention. While friction may decrease the ability of one to open the door when not fully weighted by a person, a person can simply not lift their own body when entirely weighting the apparatus. This is independent of how much a person may weigh. It is also understood that the extensions shown in the figures may be achieved in a variety of ways. The extension may be of the same piece of material as the base and bent to achieve a perpendicular relationship with the base. The extension may also be molded from a unitary piece of material including the base. The base may also be a separate piece of material that is secured to the base in a perpendicular fashion. Also, the base may be made of a different material than the base. For instance, the base may be a metal or a polymer of some type and the extension may be a metal or polymer of the same, or different type. The materials selected may provide a designed level of stiffness so as to block a door under normal force conditions without breaking. The apparatus may also provide a certain level of flexibility to allow a normal amount of force to be applied with minimal damage to the door.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular contemplated use. It is intended that the appended claims be construed to include other alternative embodiments of the invention except insofar as limited by the prior art.

1. An apparatus for stopping a door from being opened from the inside only, said apparatus comprising:
a base comprising an upper face and a lower face, said base being slideably positionable in front of said door when said door is closed and of sufficient size to accommodate a person standing upon said base; and
a perpendicular extension extending upward from at least a portion of the base, said perpendicular extension being operable to block said door from opening only when said person is standing upon said base and when said base is slideably positioned in front of said door;
wherein said base portion has a larger area than said perpendicular extension.

2. (canceled)

3. (canceled)

4. The apparatus of claim 1, wherein said base further comprises at least one movement enabling device protruding from the lower face.

5. The apparatus of claim 4, wherein said at least one movement enabling device is a retractable rotational mechanism.

6. The apparatus of claim 4, wherein said at least one movement enabling device is skid.

7. The apparatus of claim 1, wherein said base further comprises a back edge, said back edge curving upward.

8. The apparatus of claim 1, wherein said base further comprises an under door portion.

9. The apparatus of claim 8, wherein said under door portion is not the same width as the base.

10. The apparatus of claim 8, wherein said perpendicular extension comprises at least one hole enabled to accept a positioning device on said door.

11. The apparatus of claim 8, wherein said perpendicular extension comprises a front side and a back side, said back side comprising a surface enabled to non-permanently attach to said door.

12. The apparatus of claim 8, wherein said base further comprises at least one movement enabling device protruding from the lower face.

13. The apparatus of claim 8, wherein said at least one movement enabling device is a retractable rotational mechanism.

14. The apparatus of claim 12, wherein said at least one movement enabling device is skid.

15. The apparatus of claim 8, wherein said base further comprises a back edge, said back edge curving upward.

16. A method of preventing a door from being opened from the inside only, said method comprising:
placing a door block apparatus adjacent to the door, said door block apparatus comprising a base portion, said base being slideably positionable in front of said door when said door is closed and of sufficient size to accommodate a person standing upon said base, and a perpendicular extension connected to said base portion, said perpendicular extension being operable to block said door from opening only when said person is standing upon said base and when said base is slideably positioned in front of said door; and
standing on the door block apparatus by a person.

17. The method of preventing a door from being opened from the inside only of claim 16, further comprising non-permanently attaching the door block apparatus to the door.

18. The method of preventing a door from being opened from the inside only of claim 16, wherein said door block apparatus further comprises a back edge which is curved upward.

19. The method of preventing a door from being opened from the inside only of claim 16, wherein said door block apparatus further comprises an under door portion.
